(19) United States
(12) Patent Application Publication
(10) Pub. No.: US 2003/0118489 A1
(43) Pub. Date: Jun. 26, 2003

(54) Fuel processor modules integration into common housing

(76) Inventors: Mark R. Hagan, Cambridge, MA (US); William F. Northrop, Cambridge, MA (US); Jian Lian Zhao, Boston, MA (US)

Correspondence Address: ROBERT W. DIEHL, 311 S. WACKER DRIVE, 53RD FLOOR, CHICAGO, IL, 60606-6622, US

(21) Appl. No.: 10/324,906

(22) Filed: Dec. 20, 2002

Related U.S. Application Data
(60) Provisional application No. 60/345,170, filed on Dec. 21, 2001.

(51) Int. Cl. C01B 3/32

(52) U.S. Cl. 422/191; 48/198.6; 48/197 FM; 48/127.9; 48/119; 48/113; 48/62 R; 422/193; 422/200; 422/204; 422/211

(57) ABSTRACT

A housing containing two or more individual operating components called modules is disclosed. The modules themselves are independently contained in one or more vessels with attendant connectivity structures such as pipes, tubes, wires and the like. Each such vessel or device is configured to conduct at least one unit reaction or operation necessary or desired for generating or purifying a hydrogen enriched product gas formed from a hydrocarbon feed stock. Any vessel or zone in which such a unit operation is conducted, and is separately housed with respect at least one other vessel or zone for conducting a unit operation, is considered a module. Unit reactions or operations include: chemical reaction; combusting fuel for heat (burner); partial oxidation of the hydrocarbon feed stock; desulfurization of, or adsorbing impurities in, the hydrocarbon feed stock or product stream (“reformate”); steam reforming or autothermal reforming of the hydrocarbon feed stock or pre-processed (“reformate”) product stream; water-gas shifting of a pre-processed (reformate) stream; selective or preferential oxidation of pre-processed (reformate) stream; heat exchange for preheating fuel, air, or water; reactant mixing; steam generation; water separation from steam, preheating of reactants such as air, hydrocarbon fuel, and water, and the like.

### RELATED APPLICATION

The present application claims benefit of the priority of U.S. Provisional Application Ser. No. 60/345,170 filed Dec. 21, 2001.

### TECHNICAL FIELD

The present invention relates generally to fuel processors for converting hydrocarbon fuels to a hydrogen-enriched gas or reformate, and in particular, to designs directed to optimizing integration of one or more unit processes desired in reforming including integration of several chemical reactors or modules into a single housing.

### BACKGROUND OF THE INVENTION

Electrochemical devices have long been recognized as having advantages over more conventional forms of power generation. Due to the nature of the electrochemical conversion of hydrogen and an oxidant into electricity, the fuel cell is not subject to certain Carnot engine limitations, unlike typical prime movers that generate mechanical work from heat. Though fuel cells can operate on stored hydrogen, fuel cell systems utilizing fuel processors have demonstrated similar advantages utilizing hydrocarbon fuels such as gasoline and methanol, and have certain advantages in terms of storage capacity, weight, and availability of infrastructure. In addition, fuel cell systems operating on hydrocarbon fuels also have a distinct thermal efficiency advantage over traditional devices. Also, emissions such as carbon dioxide, carbon monoxide, hydrocarbons, and oxides of nitrogen are relatively low.

Despite its potential, however, fuel processor technology has remained largely untapped as a source for hydrogen for fuel cell systems for a variety of reasons. One significant reason is the size and complexity of the overall fuel processor and fuel processor/fuel cell system. In large part, this complexity arises from the need for many chemical conversion steps in going from the chemical energy contained in hydrocarbon fuels to the provision of a hydrogen-enriched gas. For this reason, it has remained very challenging to package entire fuel cell systems into small spaces; for example, in vehicle and portable applications

One obstacle to making fuel processor systems more compact is the thermal and spatial requirements of the sub-components and the connectivity between various complementary reaction vessels. Furthermore, as these complex systems are made to be more compact, it becomes even more challenging to organize reactors or modules and thermally integrate each piece of the system while maintaining an ability to assemble and service it.

Classical forms of fuel processors are typically large chemical plants, not subject to severe constraints on weight, footprint, or thermal efficiency. Therefore there is little guidance from such conventional technology and there remains a need for fuel processors that are compact, thermally efficient, and easy to service.

EP 1 057 780 A2 A assigned to Toyota, discloses an attempt to provide integration of multiple unit operations in a single device (see e.g. FIGS. 39 and 40). The disclosed design provides for sequential process or reaction modules in a reforming process and fuel conditioning process. Reactor or module sections 30 and 62 are connected via a clamped connection. A pipe 66 joins modules 62 to 64 and redirects reformate flow 180 degrees. Reactor module sections 64 and 80 are also connected by a clamp connection. The assembled fuel processor of this Toyota design is difficult to mount under the floor of a vehicle without allowing mechanical strain to be applied to at least some of these joints, including the clamped connections. Housing 61 provides an insulating function but does not appear to stabilize any of the above-discussed connections in any significant way, in particular the connections between modules 30-62, 62-64, and 64-80, respectively.

It is also noted that housing 61 is double walled and insulating is carried out by a space defined between the walls of the housing 61. Accordingly, there is a significant space utilization inefficiency in that unused interstitial space remains between the modules 62, 64 and the housing 61.

Other approaches having significant degrees of success at providing a fuel processor with optimized thermal and mechanical integration of unit processes are those concentrically arranged, e.g. nested cylinders as disclosed in U.S. Pat. Nos. 6,254,839 and 6,245,303; and WO 00/66487, all assigned to the assignee of this application. However, in certain applications, such as in on-board transportation applications, physical shape and orientation of an integrated reactor can be restricted by the particular design considerations for a particular vehicle. Accordingly, for any given reactor output desired, a concentric design may provide a reactor diameter to reactor length ratio which is not as favorable as a non-concentric design. This consideration may become more pronounced as the degree of integration within a single reactor housing increases towards providing all of the unit operations desired or necessary to provide acceptable quantity and quality of hydrogen for the application.

The present invention meets the above deficiencies in the art, as well as providing a variety of other benefits and advantages associated with the construction and use of integrated fuel processors.

### SUMMARY OF THE INVENTION

According to one aspect of the present invention, a housing contains two or more individual devices. The devices themselves are independently contained in one or more vessels with attendant connectivity structures such as pipes, tubes, wires and the like. Each such vessel or device is configured to conduct at least one unit reaction or operation necessary or desired for generating or purifying a hydrogen enriched product gas formed from a hydrocarbon feed stock.

For the purposes of the invention, any vessel or zone in which such a unit operation is conducted, and is separately housed with respect at least one other vessel or zone for conducting a unit operation, shall be referred to as a module.

Unit reactions or operations include: chemical reaction; combusting fuel for heat (burner); partial oxidation of the hydrocarbon feed stock; desulfurization of, or adsorbing impurities in, the hydrocarbon feed stock or product stream (“reformate”); steam reforming or autothermal reforming of the hydrocarbon feed stock or pre-processed (“reformate”) product stream; water-gas shifting of a pre-processed (reformate) stream; selective or preferential oxidation of pre-processed (reformate) stream; heat exchange for preheating fuel, air, or water; reactant mixing; steam generation; water separation from steam, preheating of reactants such as air, hydrocarbon fuel, and water, and the like.

According to another aspect of the invention, such modules and their attendant connectivity structures present somewhat irregular perimeter geometries and/or present somewhat asymmetric assemblies, while the housing presents a more regular and/or symmetrical cross section and/or perimeter.

According to another aspect of the invention, the interstitial space among the modules, their attendant connectivity, and the inner surface of the housing, is configured to serve a useful function. Among these useful functions are: (a) providing either a fluid or a solid substance in the interstitial space to insulate the reactors or modules components and/or their connectivity, or to assist in thermal equilibrium among same; (b) flowing fluid through the interstitial space for heat exchange to accomplish heating or cooling of the module or both; (c) providing a flow of fluid through the interstitial space for heat exchange to accomplish heating of the fluid for further use in the system, such as preheating a reactant feed stream; and, (d) providing a granular or monolithic catalyst in the interstitial space and providing a flow of fluid through the interstitial space for reaction on the catalyst.

According to another aspect of the invention, the housing provides improved mechanical support for the modules.

According to another aspect of the invention, the housing itself, in particular its end closures provide interconnection of fluid flows among the reactors or modules.

According to another aspect of the invention, either the housing, or the internal modules and their connectivity, or both, are arranged so that at least one portion of the interstitial space can be fitted with one or more unitary bodies providing for any one of insulation, catalysis, heat exchange or any combination of the above. Preferably these bodies can be made with regular geometries. The bodies may be porous, elongate or cooperatively stacked segments, or combinations of these.

According to another aspect of the invention, the housing is sized and shaped to provide a least bounding generally regular geometry to bound the modules and their connectivity.

Prior art designs for fuel processors typically stop at the level of integration of unit functions into a module. The modules are then placed wherever convenient and interconnected as required. We have found instead that when the system is best constructed as comprising more than one module, it is efficient to assemble the modules in a common housing so as to provide a physically integrated unit. The initial motivation for this assembly in a housing was to maintain the units in a fixed relationship to each other, and in some cases to minimize system heat losses. However, we have found that the process of integrating modules in a housing provides many additional unexpected benefits, particularly in the areas of manufacture, ease of repair, and service. The systematic use of design and assembly principles produces an integrated fuel processor that is both highly efficient and easy to assemble and maintain.

The following are examples of benefits provided by the integrated fuel processor of the invention: more flexibility in selecting the physical shapes of units; e.g., monolithic catalyst supports; better serviceability while retaining a very compact fuel processor. Reactors or modules can be changed out very quickly and replaced as opposed to having to dismantle an entire fuel processor assembly; utilization of the interstitial space as a conduit for flowing a heat exchange medium, including a process gas, for thermal integration of the modules. Alternatively, the interstitial space can be void of any process fluid and may contain insulating materials such as a ceramic fiber blanket. In the first instance, the housing could be a pressurized vessel; in the second instance, the housing would not need to withstand internal pressure and may be vented to the atmosphere.

### BRIEF DESCRIPTION OF THE DRAWINGS

The present invention can be more readily understood with reference to the accompanying drawings, in which like numerals are employed to designate like components throughout the disclosure, and where:

FIG. 1 is a first perspective, partially exploded view of a fuel processor in accordance with the present invention having two main modules;

FIG. 2 is a cross sectional assembled view taken along line 2-2 of the embodiment of the fuel processor shown in FIG. 1;

FIG. 3 is a schematic cross sectional side view taken along line 3-3 of the embodiment of the fuel processor shown in FIG. 1;

FIG. 4 is a second perspective view of the embodiment of the fuel processor shown in FIG. 1 without the common housing and illustrating one embodiment of module attachment to end closures;

FIG. 5 is a schematic of another embodiment of a fuel processor in accordance with the present invention having three main modules;

FIG. 5A is a cross sectional view taken along line 5A-5A of the embodiment of the fuel processor shown in FIG. 5;

FIG. 6 is a drawing (FIG. 39) from EP 1 057 780 A2 disclosing a fuel processor; and

FIG. 7 is a drawing (FIG. 40) from EP 1 057 780 A2 disclosing a fuel processor.

### DETAILED DESCRIPTION OF THE INVENTION

While this invention is susceptible of embodiment in many different forms, preferred embodiments of the invention will be described below in detail with the understanding that the present disclosure is to be considered as an exemplification of the principles of the invention and is not intended to limit the broad aspect of the invention to the embodiments disclosed. It should also be understood that not every disclosed or contemplated embodiment of the invention needs to utilize all of the various principles disclosed herein to achieve benefits according to the invention.

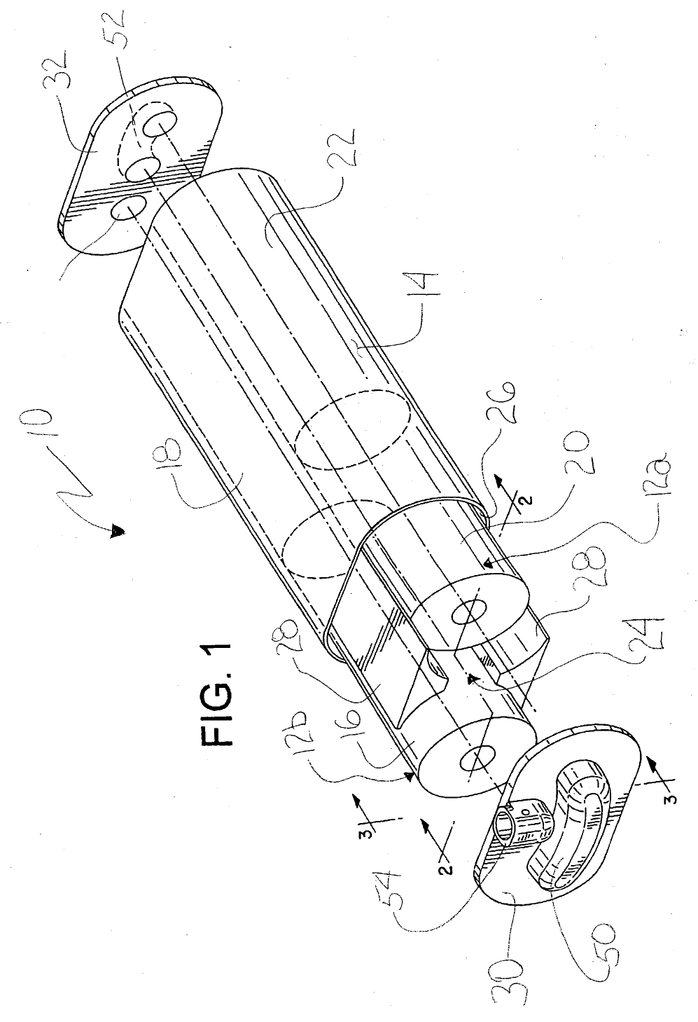

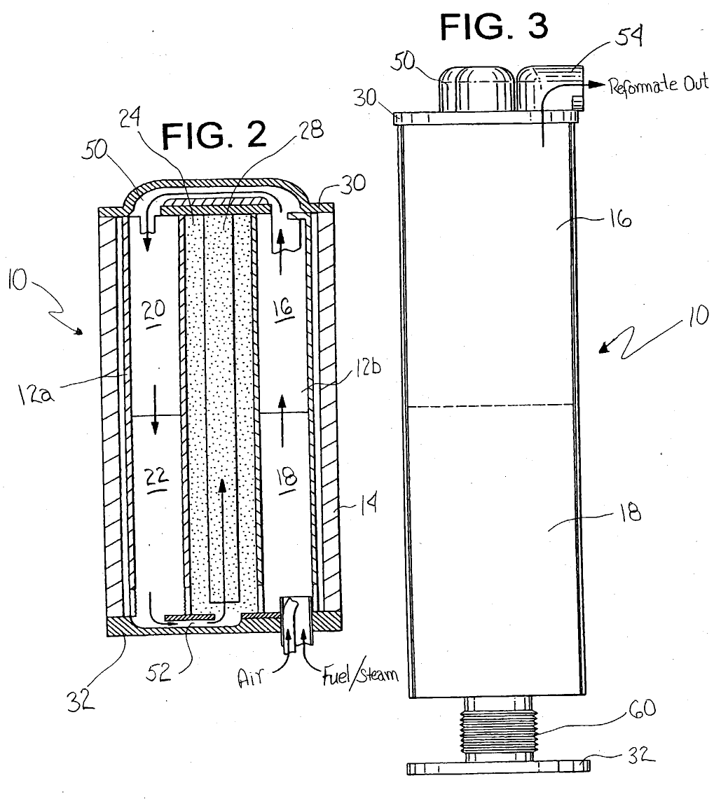

FIGS. 1-4 disclose a fuel processor 10 for converting hydrocarbon fuel into a hydrogen-enriched gas or reformate. The fuel processor 10 includes two modules 12a and 12b, each of which is self-contained and configured to conduct a unit operation required for reforming hydrocarbons in the hydrocarbon fuel feed stock. As necessary or desired the fuel processor 10 sufficiently purifies the resulting syn-gas or reformate for its ultimate use, such as integration with a fuel cell (not shown).

Unit Operation And Orientation Of Modules

A housing 14 houses two modules, first module 12a and second module 12b. Each module 12a, 12b is configured to conduct at least one unit reaction/operation required toward a desired yield of hydrogen. The unit reactions contemplated for the example of fuel processor 10 may be carried out by, in a preferred operational order, a burner, a reformer (selected from a partial oxidation (POx) reactor, a steam reformer, or a combination autothermal reformer), a shift reactor (both high temperature and low temperature shift), and a preferential oxidation (PrOx) reactor. All of these unit reactions need not be present or identically arranged with their respective reactor components for all uses. For example, the module 12a may include a partial oxidation reaction in section 20 thermally coupled with a steam reforming reaction of the hydrocarbon feed stock (the combination thereof providing autothermal reforming or “ATR”) in section 22, to generate a reformate. Both a high temperature water-gas shift (HTS) and a low temperature water-gas shift (LTS) reaction may be carried out in two succeeding sections 16 and 18 of module 12b.

Modules 12a, 12b, are aligned in parallel and together present a somewhat irregular and interrupted perimeter geometry. The obround housing 14 on the other hand, presents a more regular and/or symmetrical cross section and/or perimeter. The housing 14 is sized and shaped to provide a least bounding generally regular geometry (obround in this case) to bound the side-by-side cylindrical modules 12a and 12b, according to one aspect of the invention.

In other embodiments, as with housing 14, the housing shape is also selected based on its ease of manufacture and the ability to fit the space allocated to the particular fuel processor. Another consideration is whether the housing is to be pressurized. Generally, the housing is sized to provide efficient packaging and serviceability of the modules and associated connections.

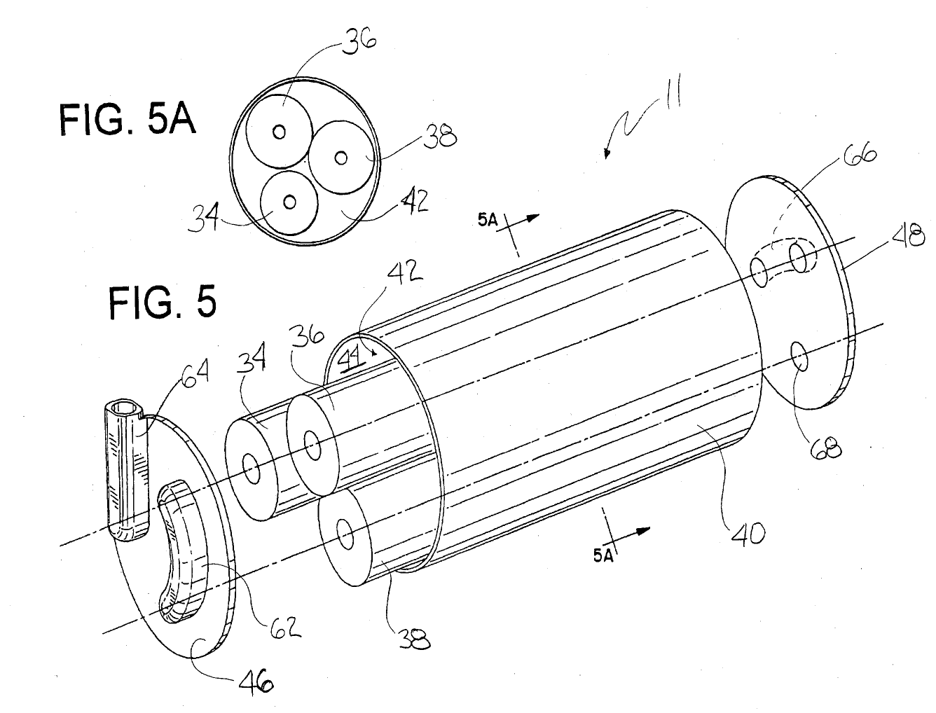

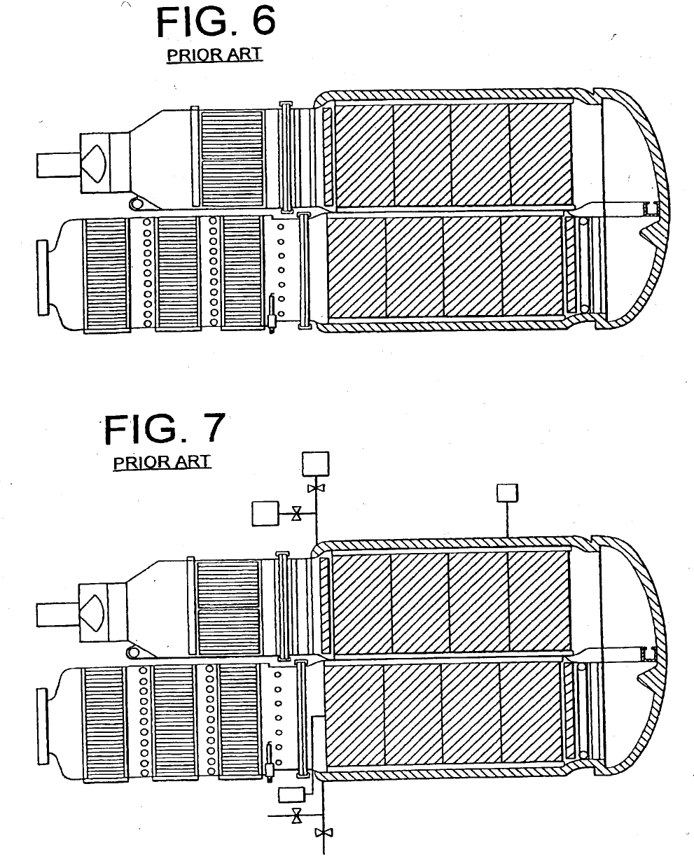

For example, FIG. 5 discloses a fuel processor 11 having three (3) main cylindrical modules 34, 36, and 38 each for conducting distinct unit operations. A least bounding geometry, or right circular cylindrical housing 40, houses the reactors or modules 34, 36, 38. It should be understood that other geometries, for example a triangular cylinder could provide a least bounding regular geometry for housing the three modules 34-38.

The unit processes contemplated by way of example in fuel processor 11 are; ATR in module 38; HTS and LTS successively in module 36; and preferential oxidation in one or more stages or thermal gradients in module 34.

Interstitial Space

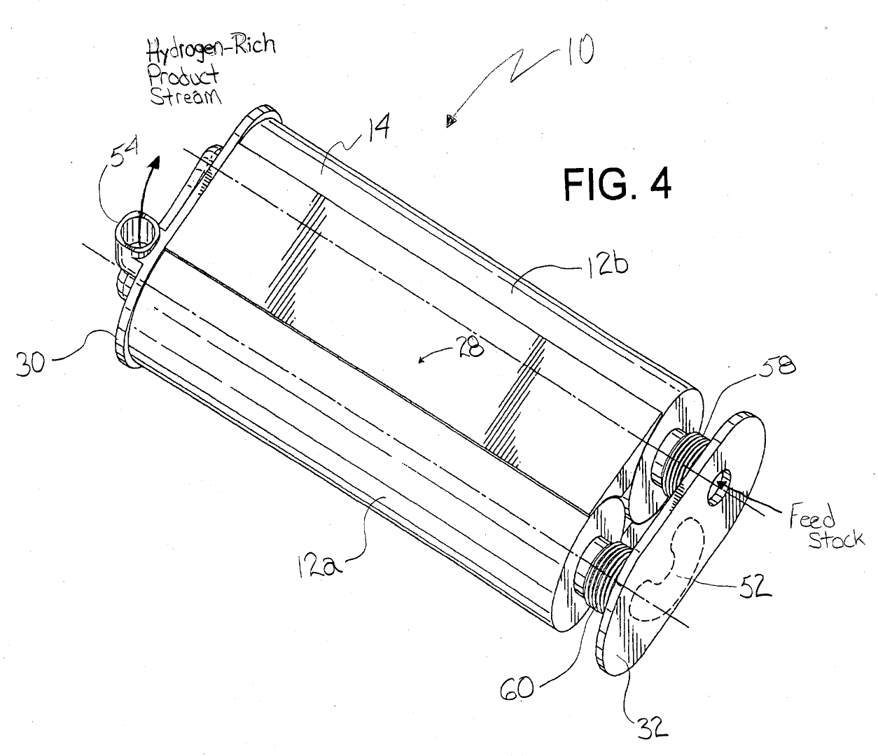

FIGS. 1-3 disclose an interstitial space 24 defined among the modules 12a and 12b and an inner surface 26 of the housing in fuel processor 10. FIG. 4 discloses an interstitial space 42 defined among the modules 34-36 and an inner surface 44 of a housing 40.

FIG. 1 discloses that a significant portion of the interstitial space 24 of fuel processor 10 is advantageously occupied by insert modules 28. The inserts 28 conduct a unit operation but advantageously are designed to fit the interstitial space left by housing two cylinders by an obround housing. In other words, the interstitial space 24 defines the vessel in which this unit operation occurs. In one embodiment the inserts 28 are preferably a foam structure which can also provide insulation of the modules 12a and 12b and heat exchange with the modules 12a and 12b. In another embodiment, a heat exchanger such as that disclosed in U.S. Ser. No. 60/304,987 may be configured to fit into irregularly shaped interstitial spaces.

FIG. 2 discloses a preferred use of the inserts 28 and the interstitial space 24. In the disclosed embodiment, the foam inserts support one or more catalysts suitable for promoting preferential oxidation of CO in the reformate stream generated by modules 12a and 12b.

It is contemplated that in other embodiments fuel processors such as 10 or 11 having corresponding interstitial spaces such as 24 or 42 could: (a) permit routing of individual conduits configured to exchange heat with a fluid in the interstitial space and/or the modules, or both, such as for preheating a feed stock in the conduit; (b) be configured as in fuel processor 10 to itself substantially define a conduit for a fluid flow fluid for heat exchange with the modules including heat exchange modules; (c) house one or more solid substances to insulate all or part of the modules and/or their connectivity; or (d) house a granular catalyst or absorbents or adsorbents pretreatment of feed stock or a post-treatment of reformate. Of course, interstitial space 42 of fuel processor 11 could be configured to contain foam inserts, such as inserts 28 and function in a similar manner, albeit the inserts having a slightly different shape.

Mechanical Connection

FIGS. 1-4 disclose the unique structural integrity, modularity, and fluid connectivity provided by utilization of the principles of the invention. FIG. 4 in particular, discloses the fuel processor 10 without its housing 14. In this view is can be seen that the modules 12a, 12b are fixed by end closures 30,32 in secure alignment with each other, and with respect to the perimeter where housing 14 will reside. Because the modules 12a, 12b are secured, the inserts 28 are easily stabilized by having a shape that inter fits within an interstitial space between the modules 12a, 12b and the housing inner surface 26.

Fuel processor 11 (FIG. 5) is constructed in a similar manner, whereby the modules 34-38 are secured in proper alignment by connection to end closures 46 and 48.

In other embodiments, it is contemplated that added support for the modules could be provided by spacers placed between the modules or the inner surfaces of the housings 14 and 40 of the fuel processors 10 and 11. Such spacers may be in the form of discrete mechanical shims, brackets or the like, or could be comprised of sheets of metal foam, mesh, expanded metal, dimpled metal or screen so as not to displace fluid or restrict fluid flow.

In other embodiments it is contemplated that mechanical stability will be increased if the modules are cross-braced or otherwise supported against each other. It may also be convenient to shape the housing so that when it is fitted down over the modules, contacts or attachments between the modules and the inside of the housing increase the mechanical stability of the modules with respect to each other and to the cover.

In general, according to the invention, when modules are secured to end caps/closures and are provided with internal spacing support when required, then the integrated fuel processor does not place any strain on the seals connecting the modules.

Fluid Communication Between Modules

FIGS. 1, 3, 4 and 5, disclose the advantageous interconnection of fluid flows among the modules 12a ,12b, and the interstitial space 24 as disclosed in FIGS. 1-3 and provided by the invention.

In fuel processor 10, a raised cross-over manifold 50 integral with end closure 30 interconnects one end of each of modules 12a and 12b for flow of reformate as shown in FIG. 2. Likewise, an embedded channel-type cross over manifold 52 is integral with end closure 32 for providing fluid communication between module 12a and the interstitial space 24, in the manner disclosed in FIG. 2. While these fluid manifolds are disclosed as relatively integral with end closures 30, 32 it is contemplated that any suitable pipe, conduit or the like may be suitably attached to, or otherwise integrated into an end closure to receive benefits according to the invention.

An outlet pipe 54 is provided on end closure 30 for exiting hydrogen enriched product gas and for connection with appropriate external routing to an end use, such as a fuel cell. Inlet port 56 is provided on end closure 32 for supplying fuel, fuel and steam, fuel and water, and oxygen, or any combination thereof as desired for carrying out the reforming process desired in module 12b.

FIG. 4 discloses that the modules 12a, 12b are connected to end closure 32 by bellows connectors 58 and 60. These connectors advantageously provide stable alignment of the modules while permitting relative longitudinal expansion and contraction of the modules versus the housing 14 during thermal excursions of the fuel processor 10.

FIG. 5 discloses fluid connectivity into, out of, and within the fuel processor 11 in a like manner to that of fuel processor 10. This is accomplished through manifolds 62 and 66 on end closures 46,48 respectively and inlet 68 and outlet 64 on end closures 48, 46 respectively.

In general a further advantage of the combination of the housing and the mani-foldbearing end closures is that assembly is markedly simplified. A significant fraction of the required “plumbing” (interconnections among fluid flows) can be built into the manifolds (and into the modules), so that many fewer individual connections will be required to assemble a fuel processor.

To that end, passages may be provided in the end units, or other portions of the processor, in any known way. These includes machining, forming, stamping, drilling, or welding or brazing of other structures onto the end caps, and combinations of these. The passages will be provided with fittings into or onto which the modules may be affixed. Means of fixation of modules on the end fittings or the manifolds attached to them can also be any known in the art, with due regard for the nature, pressure and temperature of the fluids to be passed through the manifold.

Modularity

As can clearly be seen in view of the above disclosures, the modules 12a,12b of fuel processor 10 and 34-38 of fuel processor 11, can be easily assembled and replaced by removal of either one or both of the end closures (30, 32 or 46, 48) of the respective housings 14 and 40. This is due in one respect to the convenient arrangement of the physical vessels comprising the modules. It is also due in another respect by the convenient grouping of unit functions into a particular module. For example, certain catalysts may be poisoned more readily by certain contaminants than others, certain catalysts may have a shorter operational life than others, etc. Thus, in the present designs, catalysts for HTS can be removed without removal of the ATR module or its catalyst section and vice versa. Likewise, the choice of which catalysts to put together in a module can be optimized according to expected needs for changing during operation.

This also highlights the linear concentric modularity of module sections, such as sections 16 and 18 (HTS and LTS, respectively) and 20,22 (partial oxidation and steam reforming). The modules 12a,12b can in a desired embodiment separate into sections and hence even a section of a module may be easily assembled or removed and replaced by simple removal of the end closures.

In general, according to the invention, for efficiency, several functional units may be integrated into a single module, but it is not always practical, or even desirable, to integrate the entire system into a single module. Considerations affecting the degree of modularity include ease of assembly and repair, replacement of consumables, thermal compatibility, and system efficiency.

All modules can contain one or more of catalysts, catalytic reaction zones, adsorbents, heat exchangers, mixers, or other units. These are fully contained within a given module or sections thereof. However, according to the invention, the interstitial space not taken up by a self-contained module, may contain these individual items or assist in these functions as desired for a particular design. Leak-tight modules such as heat exchangers that can assume odd shapes to fill voids can be also used.

Heat Exchange Configurations

As disclosed with respect to fuel processors 10 and 11, in modular configurations, individual modules may contain more than one unit function integrated into the module. For example, it is usually expedient (although not required in the invention) to integrate the heat-absorbing steam reforming reaction into a module so as to provide direct contact with available heat emitting reactions, particularly partial oxidation units, auxiliary heat burners, exothermic reactions, autothermal reactions, burners and/or high temperature water gas shift units; and to combine these with integrated heat exchange means. On the other hand, lower temperature reactions may expediently be placed in separate modules, or in a common second module.

Heat exchanger modules typically transfer heat from hot components, such as the exhaust of a catalytic burner and the reformate, to components requiring preheating, such as water requiring conversion to steam, or fuel requiring vaporization.

Additionally, modularization increases the efficiency of heating elements that are disposed between the inner surface of a thermally insulated module wall and an element requiring heating, such as a steam reformer. A heater such as a burner, when employed as an ignition source, will operate much more efficiently, particularly if its exhaust can be used as a needed auxiliary heat source or thermal insulator. After running the fuel processor for a short while, the burner's ignition source can often be extinguished when the burner material attains a sufficiently high temperature to ignite incoming reactants. Accordingly, in other embodiments of the invention a fuel processor comprising a partial oxidation module or and ATR module, can include a burner the exhaust of which can be flowed in the interstitial space to heat a thermal conductor which is disposed about the module, and, optionally, contacts by direct convection the module.

In other embodiments, anode waste gas from a fuel cell can be fed to a module to assist reforming, or it can be fed to a burner incorporated into a module, or it can be directed through an interstitial space between modules for heat exchange, or a combination of these.

Method

As best disclosed in FIG. 2, a method of reforming hydrocarbon fuels in fuel processor 10 according to the invention includes conducting a first unit operation on a reaction stream flowing in a first direction in module 12b, and generating a reformate from a first unit operation, ATR. At the same time, reformate is flowed in a second direction through module 12a while conducting a second unit operation water-gas-shift. The flow direction through these modules 12a,12b is in opposite directions.

Residence time of reactants in a reactor section (module or sub-component of a module) e.g. in the flow through a catalyst bed, (such as is the case with catalytic partial oxidation, steam reforming, autothermal reforming, water-gas-shift, and preferential oxidation), is a significant factor in efficacy and efficiency of a fuel processor. The length of a such reaction zone or reactor is a significant factor in determining residence time. (Other factors influencing residence time, or its inverse, space velocity, include pressure, bed cross sectional area, and pore volume of the catalyst bed. Advantageously according to the invention, the total residence time of reactants flowing through all of the unit operations of fuel processor 10 can be twice as long as a fuel processor of equivalent overall length, i.e. from end closure to end closure. Put another way, if modules 12a and 12b were not packaged side by side but in a linear succession, the fuel processor 10 would have to be approximately twice as long. For some applications, such a configuration would be unsuitable. The structural integrity too, of such a linearly aligned processor would be likely compromised by comparison.

The above advantage is multiplied in fuel processor 10 by use of the interstitial space 24 as a vessel for conducting the unit operation of preferential oxidation. This use of common housing 14 for non-concentric reaction zones reduces overall length of fuel processor 10 by approximately a factor of three (3) with respect to the modules contemplated in fuel processor 10.

It is also contemplated that further method or process advantages will be achieved by providing a common housing for at least two non-concentrically aligned modules wherein the interstitial space is used as a vessel for simultaneously exchanging heat among, a heat exchange fluid flowing in either one of the first or second directions in connection with both the first and second unit operations. In particular a process advantage is achieved where the heat exchange fluid is reformate generated in the second unit operation, and more particularly when catalyzing a reaction in the heat exchange fluid by flowing the fluid through a catalyst while simultaneously exchanging heat. In particular, such a process is disclosed in fuel processor 10 as conducting preferential oxidation on porous monolithic supports 28 aligned in the direction of flow of the heat exchange fluid.

Method Of Constructing A Fuel Processor

As disclosed in FIGS. 1-5, the present invention provides advantages in the manufacture and maintenance of a fuel processor. Specifically processes for making a fuel processor include providing at least two modules configured to conduct at least one distinct unit operation each and aligning the modules non-concentrically. The process also includes housing the modules in a common housing and securing each module proximate its opposite ends to, or proximate to, an end closure of the housing.

As also disclosed in FIGS. 1-5, another aspect of a process according to the invention is configuring the fuel processor so that an interstitial space among the modules and the housing can be used as a vessel or conduit for useful work, such as for performing a unit operation therein without the need for further modularization or the provision of further vessels.

Although this specification discloses, illustrates, and describes specific embodiments, numerous modifications come to mind without significantly departing from the spirit of the invention. The scope of the protection is limited only by the scope of the accompanying claims.

We claim:

1. A fuel processor for converting hydrocarbon fuel into hydrogen gas, the fuel processor comprising:
at least two modules, each of the at least two modules being configured to conduct at least one distinct unit operation required for reforming hydrocarbons in a fuel, and the at least two modules being non concentrically aligned with respect to one another;
a housing for housing the at least two modules together; and,
an interstitial space within the housing juxtapositioned to the individual modules and an inner surface of the housing, the interstitial space being configured to provide at least one of the functions selected from the group consisting of conducting a fluid through the interstitial space for heating the modules, conducting a fluid through the interstitial space for cooling the modules, conducting a fluid through the interstitial space for preheating a fluid, conducting a fluid through the interstitial space and providing a catalyst therein for reaction, providing an insulating non-gaseous material in the interstitial space for insulating the modules, co-housing one or more monolithic catalyst supports, co-housing one or more granular catalyst supports, and any combinations thereof.

2. The fuel processor of claim 1 wherein a perimeter bounding the modules is irregular and wherein the housing has a regular cross-sectional geometry bounding the at least two modules.

3. The fuel processor of claim 2 wherein the regular cross-sectional geometry is selected from the group of shapes consisting of round, circular, obround, oval, elliptical, square, rectangular, triangular, and regular polygonal.

4. The fuel processor of claim 1 wherein the housing provides mechanical support for the modules.

5. The fuel processor of claim 1 further comprising an end closure for the housing wherein the modules are secured by attachment to at least one end closure.

6. The fuel processor of claim 1 further comprising end closures wherein at least one end of each module is attached to an end closure in a way that permits relative movement due to thermal expansion between or among the modules and the housing.

7. The fuel processor of claim 1 wherein the housing comprises an integral path for fluid communication between the modules.

8. The fuel processor of claim 7 wherein the integral path for fluid communication comprises a conduit integrated with an end closure of the housing.

9. The fuel processor of claim 1 wherein the housing cross section is defined by a generally regular geometry providing a least bounding perimeter about the modules.

10. The fuel processor of claim 1 wherein each module conducts unit reactions selected from the group consisting of combustion of fuel for heat, partial oxidation of a hydrocarbon fuel, desulfurization of a feed stock, adsorption of impurities in a reformate or feed stock, steam reforming of a hydrocarbon feed stock or a pre-oxidized (reformate) stream, water-gas shifting of a pre-processed steam reformed or partially oxidized (reformate) stream, selective or preferential oxidation of pre-processed (reformate) stream, heat exchange for preheating fuel, air, or water, reactant mixing, steam generation, and any combination thereof.

11. The fuel processor of claim 1 wherein the fuel processor is configured to provide a flow through the interstitial space of a process fluid for at least one of thermal insulation of the modules, heat exchange and combinations of same.

12. The fuel processor of claim 1 wherein the interstitial space contains a material for insulating the modules, the material being selected from the group consisting of a flowing process fluid, a solid or semi-solid such as metal or ceramic fibers, a porous support, a foamed material, or any combination thereof.

13. The fuel processor of claim 1 further comprising at least one vent to the atmosphere from the interstitial space.

14. The fuel processor of claim 1 further comprising at least one end closure for the housing, the end closure having at least one opening interfaced with external plumbing attached to the end plate.

15. The fuel processor of claims 1 further comprising one end closure for the housing having an integral manifold for fluid communication between at least one of the modules and conduit external to the housing.

16. The fuel processor of claim 1 further comprising:
a housing inlet in communication with the interstitial space; and,
a housing outlet in communication with the interstitial space.

17. The fuel processor of claim 1 wherein the at least two modules are positioned in close proximity to each other so as to achieve a compact, efficient utilization of a volume within the housing.

18. The fuel processor of claim 1 further comprising a heat exchang conduit positioned within the interstitial space for exchanging heat with fluid flow in the interstitial space.

19. The fuel processor of claim 1 wherein each of the at least two modules has an elongated dimension and the modules are positioned so the elongated dimensions of the modules substantially align in parallel.

20. The fuel processor of claim 1 further comprising a reaction catalyst disposed in the interstitial space.

21. The fuel processor of claim 1 further comprising an auxiliary burner incorporated into a first module.

22. The fuel processor of claim 21 wherein the auxiliary burner comprises an exhaust which heats a thermal conductor disposed about at least one module.

23. The fuel processor of claim 21 wherein the auxiliary burner comprises an exhaust which heats a thermal conductor disposed about the auto-thermal reforming module.

24. The fuel processor of claim 1 further comprising process conduit in the interstitial space and in operative association with the modules for conducting their respective unit operations, the process conduit being selected from the group consisting of heat exchangers, boiler/steam tubes, electrical conduit, fluid conduit, or any combination thereof.

25. The fuel processor of claim 1 further comprising an anode gas combustion burner incorporated into at least one module.

26. A fuel processor for converting hydrocarbon fuel into hydrogen gas, the fuel processor comprising:
at least three modules, each of the at least three modules being configured to conduct at least one unit operation required for reforming hydrocarbons in a fuel the at least three modules being non-concentrically aligned with respect to one another; and,
a housing for housing the at least three modules together.

27. The fuel processor of claim 26 further comprising an interstitial space within the housing among the individual modules and an inner surface of the housing, the interstitial space being configured to provide at least one of the functions selected from the group consisting of conducting a fluid through the interstitial space for heating the modules, conducting a fluid through the interstitial space for cooling the modules, conducting a fluid through the interstitial space for preheating a fluid, conducting a fluid through the interstitial space and providing a catalyst therein for reaction, providing an insulating non-gaseous material in the interstitial space for insulating the modules, co-housing one or more monolithic catalyst supports, co-housing one or more granular catalyst supports, and any combinations thereof.

28. The fuel processor of claim 26 wherein a perimeter bounding the modules is irregular and wherein the housing has a regular cross-sectional geometry bounding the at least three modules.

29. The fuel processor of claim 28 wherein the regular cross-sectional geometry is selected from the group of shapes consisting of round, circular, obround, oval, elliptical, square, rectangular, triangular, and regular polygonal.

30. The fuel processor of claim 26 wherein the housing provides mechanical support for the modules.

31. The fuel processor of claim 26 further comprising an end closure for the housing wherein the modules are secured by attachment to at least one end closure.

32. The fuel processor of claim 30 further comprising an end closure for the housing wherein the modules are secured by attachment to at least one end closure.

33. The fuel processor of claim 26 further comprising end closures wherein at least one end of each module is attached to an end closure in a way that permits relative movement due to thermal expansion between and among the modules and the housing.

34. The fuel processor of claim 26 wherein the housing comprises an integral path for fluid communication between the modules.

35. The fuel processor of claim 34 wherein the integral path for fluid communication comprises a conduit integrated with an end closure of the housing.

36. The fuel processor of claim 26 wherein the housing cross section is defined by a generally regular geometry providing a least bounding perimeter about the modules.

37. The processor of claim 36 wherein the modules and housing are arranged such that a module may be removed and replaced separately from the housing with minimal disruption to other modules.

38. The processor of claim 36 wherein at least one module is removable from the housing without having to remove another module.

39. The fuel processor of claim 26 wherein each module conducts unit reactions selected from the group consisting of combustion of fuel for heat, partial oxidation of a hydrocarbon fuel, desulfurization of a feed stock, adsorption of impurities in a reformate or feed stock, steam reforming of a hydrocarbon feed stock or a pre-oxidized (reformate) stream, water-gas shifting of a pre-processed steam reformed or partially oxidized (reformate) stream, selective or preferential oxidation of pre-processed (reformate) stream, heat exchange for preheating fuel, air, or water, reactant mixing, steam generation, and any combination thereof.

40. The fuel processor of claim 27 wherein the fuel processor is configured to provide a flow through the interstitial space of a process fluid for at least one of thermal insulation of the modules, heat exchange and combinations thereof.

41. The fuel processor of claim 27 wherein the interstitial space contains a material for insulating the modules, the material being selected from the group consisting of a flowing process fluid, a solid or semi-solid such as metal or ceramic fibers, a porous support, a foamed material, or any combination thereof.

42. The fuel processor of claim 41 further comprising at least one vent to the atmosphere from the interstitial space.

43. The fuel processor of claim 27 further comprising at least one vent to the atmosphere from the interstitial space.

44. The fuel processor of claim 27 further comprising at least one end closure for the housing, the end closure having at least one opening interfaced with external plumbing attached to an end plate.

45. The fuel processor of claims 27 further comprising one end closure for the housing having an integral manifold for fluid communication between at least one of the modules and conduit external to the housing.

46. The fuel processor of claims 35 further comprising one end closure for the housing having an integral manifold for fluid communication between at least one of the modules and conduit external to the housing.

47. The fuel processor of claim 27 further comprising:
a housing inlet in communication with the interstitial space; and,
a housing outlet in communication with the interstitial space.

48. The fuel processor of claim 42 further comprising:
a housing inlet in communication with the interstitial space; and,
a housing outlet in communication with the interstitial space.

49. The fuel processor of claim 44 further comprising:
a housing inlet in communication with the interstitial space; and,
a housing outlet in communication with the interstitial space.

50. The fuel processor of claim 45 further comprising:
a housing inlet in communication with the interstitial space; and,
a housing outlet in communication with the interstitial space.

51. The fuel processor of claim 26 wherein the at least two modules are positioned in close proximity to each other so as to achieve a compact, efficient utilization of a volume within the housing.

52. The fuel processor of claim 42 further comprising a heat exchange conduit positioned within the interstitial space for exchanging heat with fluid flow in the interstitial space.

53. The fuel processor of claim 44 further comprising a heat exchange conduit positioned within the interstitial space for exchanging heat with fluid flow in the interstitial space.

54. The fuel processor of claim 45 further comprising a heat exchange conduit positioned within the interstitial space for exchanging heat with fluid flow in the interstitial space.

55. The fuel processor of claim 47 further comprising a heat exchange conduit positioned within the interstitial space for exchanging heat with fluid flow in the interstitial space.

56. The fuel processor of claim 27 wherein each of the at least three modules has an elongated dimension and the modules are positioned so the elongated dimensions of the modules substantially align in parallel.

57. The fuel processor of claim 27 further comprising a reaction catalyst disposed in the interstitial space.

58. The fuel processor of claim 40 further comprising a reaction catalyst disposed in the interstitial space.

59. The fuel processor of claim 41 further comprising a reaction catalyst disposed in the interstitial space.

60. The fuel processor of claim 26 wherein a first module is configured to conduct auto-thermal reforming, a second is configured to conduct a water-gas shift reaction, and a third is configured to conduct a preferential oxidation reaction.

61. The fuel processor of claim 26 further comprising an auxiliary burner incorporated into a first module.

62. The fuel processor of claim 61 wherein the auxiliary burner comprises an exhaust which heats a thermal conductor disposed about at least one module.

63. The fuel processor of claim 61 wherein the auxiliary burner comprises an exhaust which heats a thermal conductor disposed about the auto-thermal reforming module.

64. The fuel processor of claim 27 further comprising process conduit in the interstitial space and in operative association with the modules for conducting their respective unit operations, the process conduit being selected from the group consisting of heat exchangers, boiler/steam tubes, electrical conduit, fluid conduit, or any combination thereof.

65. The fuel processor of claim 40 further comprising process conduit in the interstitial space and in operative association with the modules for conducting their respective unit operations, the process conduit being selected from the group consisting of heat exchangers, boiler/steam tubes, electrical conduit, fluid conduit, or any combination thereof.

66. The fuel processor of claim 41 further comprising process conduit in the interstitial space and in operative association with the modules for conducting their respective unit operations, the process conduit being selected from the group consisting of heat exchangers, boiler/steam tubes, electrical conduit, fluid conduit, or any combination thereof.

67. The fuel processor of claim 57 further comprising process conduit in the interstitial space and in operative association with the modules for conducting their respective unit operations, the process conduit being selected from the group consisting of heat exchangers, boiler/steam tubes, electrical conduit, fluid conduit, or any combination thereof.

68. The fuel processor of claim 26 further comprising an anode gas combustion burner incorporated into at least one module.

69. The fuel processor of claim 61 further comprising an anode gas combustion burner incorporated into at least one module.

70. A method of reforming hydrocarbon fuels comprising the steps of:
flowing a feed stream in a first direction;
generating a reformate from a first unit operation;
flowing the reformate in a second direction opposite the first;
conducting a second unit operation on the reformate; and,
simultaneously exchanging heat in an interstitial space about a system module via fluid flow there through among:
(a) a heat exchange fluid flowing in either one of the first or second directions, and,
(b) the first and second unit operations.

71. The method of claim 70 wherein the heat exchange fluid is reformate generated in the second unit operation.

72. The method of claim 71 further comprising the step of catalyzing a reaction in the heat exchange fluid simultaneously with the step of exchanging heat.

73. The method of claim 72 wherein a catalyst used in the step of catalyzing a reaction promotes preferential oxidation of carbon monoxide.

74. The method of claim 71 further comprising a catalyst provided on a porous monolithic support aligned in the direction of flow of the heat exchange fluid.

75. A method of reforming hydrocarbon fuels comprising the steps of:
conducting at least two distinct unit operations in two respective individually contained modules which are non-concentrically aligned and contained within a housing; and,
conducting at least a third unit operation in an interstitial space defined among the modules and an inner surface of the housing.

76. The method of claim 75 wherein the step of conducting at least two unit operations in two respective individually contained modules further comprises the step of selecting the unit operations from the group consisting of partial oxidation, steam reforming, water gas shift and any combination thereof.

77. The method of claim 75 wherein the step of conducting at least one third unit operation in an interstitial space further comprises the step of selecting the unit operation from the group consisting of active heat exchange by a flowing heat exchange medium, preferential oxidation of a reformate generated in the first two unit operations, preheating of a feed stock including one of fuel, air, or water, generating steam, and any combination thereof.

78. A method of constructing a fuel processor comprising the steps of:
providing at least two modules configured to conduct at least one unit operation each;
aligning the modules non-concentrically;
housing the modules in a housing;
securing each module by its opposite ends to an end closure of the housing.

79. The method of claim 78 further comprising the step of configuring an interstitial space defined among the modules and an inner surface of the housing so that at least one unit operation can be conducted in the interstitial space.
